(19) United States
(12) Patent Application Publication
(10) Pub. No.: US 2014/0093669 A1
(43) Pub. Date: Apr. 3, 2014

(54) PROCESS FOR PROTECTING A COMPONENT, PROCESS FOR LASER DRILLING AND COMPONENT

(71) Applicants: Christopher Degel, Berlin (DE); Andrea Massa, Berlin (DE); Rolf Wilkenhöner, Kleinmachnow (DE); Adian Wollnik, Berlin (DE)

(72) Inventors: Christopher Degel, Berlin (DE); Andrea Massa, Berlin (DE); Rolf Wilkenhöner, Kleinmachnow (DE); Adian Wollnik, Berlin (DE)

(21) Appl. No.: 14/022,261

(22) Filed: Sep. 10, 2013

(30) Foreign Application Priority Data
Oct. 1, 2012 (EP) 12186769.1

(51) Int. Cl. F01D 5/28; B29D 22/00

(52) U.S. Cl. CPC F01D 5/286; B29D 22/00
USPC 428/36.4; 264/400

(57) ABSTRACT

A process is provided for protecting a component during a laser machining of the component with a hollow space. The process includes filling the hollow space with Teflon powder at least in the region of the region to be machined. The Teflon powder is introduced into the hollow space with a gelling agent.

### CROSS REFERENCE TO RELATED APPLICATIONS

This application claims priority of European Patent Office application No. 12186769.1 EP filed Oct. 1, 2012. All of the applications are incorporated by reference herein in their entirety.

### FIELD OF INVENTION

The invention relates to a process for laser drilling and to a corresponding protection process and to a component in which a filler material is introduced into the hollow component.

### BACKGROUND OF INVENTION

High-temperature components such as turbine blades or vanes are internally cooled, with air or superheated steam additionally emerging through film-cooling holes in order to additionally protect the surface.

Therefore, through-bores have to be made in the hollow cast component. In this respect, however, the inner structures must not be damaged or must not be damaged to a great extent when drilling when the laser beam acts when it breaks through into the interior of the hollow component.

A material which is hard at room temperature is often heated, fluidified and introduced into the hollow space under pressure. This is followed by the laser radiation, in which case the material then has to be removed again by a complex and long burning-out process.

### SUMMARY OF INVENTION

It is an object of the invention, therefore, to solve the aforementioned problem.

The object is achieved by the features of the independent claim(s).

The dependent claims list further advantageous measures which can be combined with one another, as desired, in order to obtain further advantages.

### BRIEF DESCRIPTION OF THE DRAWINGS

FIG. 1 schematically shows a laser drilling apparatus with a component,

FIG. 2 shows a turbine blade or vane,

FIG. 3 shows a list of superalloys.

### DETAILED DESCRIPTION OF INVENTION

The figures and the description represent merely exemplary embodiments of the invention.

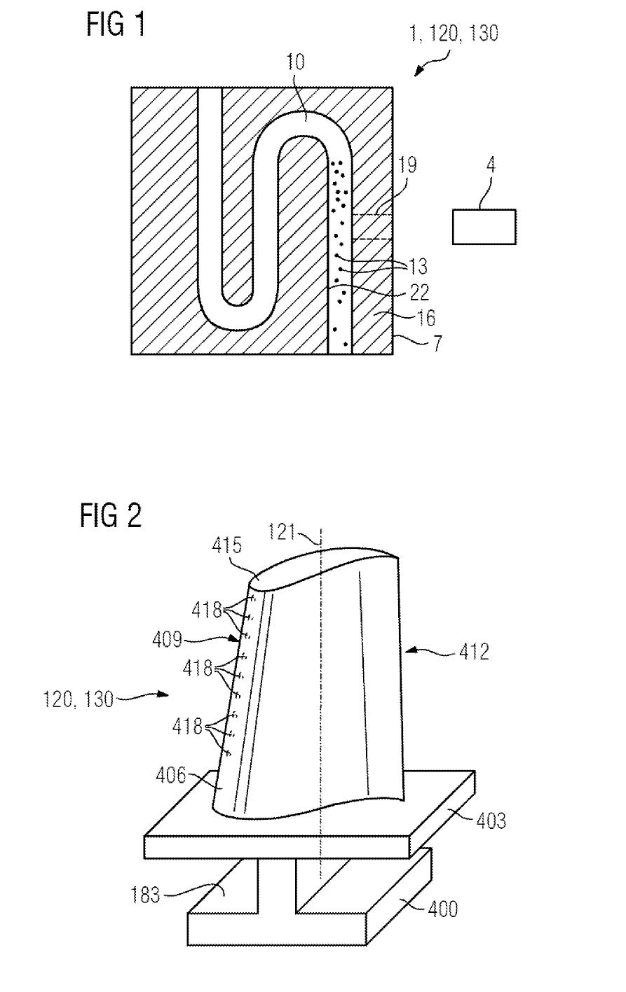

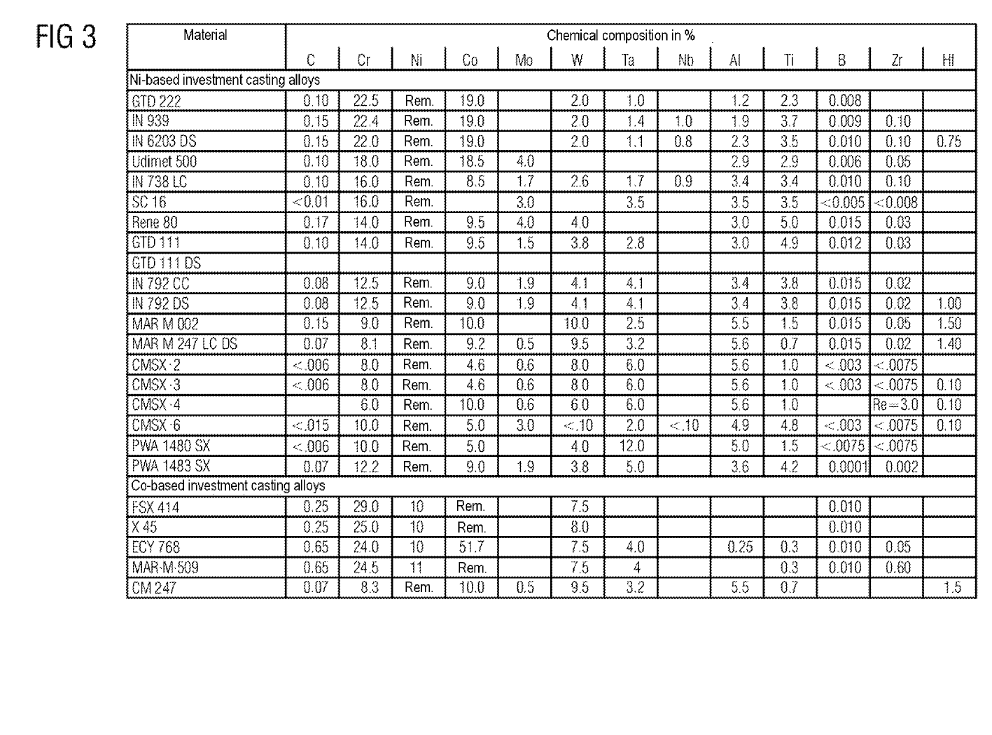

FIG. 1 shows, merely as an exemplary hollow component 1, a section of a turbine blade or vane 120, 130 (FIG. 2) made of a nickel-based or cobalt-based alloy (preferably as per FIG. 3), which has a hollow space 10.

A through-hole 19 (explained merely by way of example hereinbelow)—indicated by dashed lines—is to be made in particular through the wall 16 of the hollow space 10 of the component 1, 120, 130 in the region 19.

This is effected by a laser 4 (or electron gun), the beam of which removes material from the wall 16 proceeding from the surface 7. When it breaks through into the hollow space 10, the inner structure 22 in the hollow space 10 of the hollow component 1, 120, 130 could become damaged.

In order to prevent this, Teflon powder 13 is introduced into the hollow space 10 at least in the region of the through-hole 19 to be produced.

In this respect, the Teflon powder 13 is introduced into the hollow space 10 by way of a carrier liquid.

This is preferably water-based.

Here, it is mixed with a gelling agent, in particular gelatine, in order to produce a suspension which is then preferably left to dry out or solidify.

The proportion of the gelling agent is preferably 50 g/l-300 g/l.

A surfactant, in particular sodium dodecyl hafnate, can likewise be used with preference, very particularly in an amount of 0.01 g/l-0.5 g/l, in order to improve the filling capacity.

The Teflon powder 13 preferably has a grain size of 10 μm-1000 μm and therefore has a low surface activity.

After the laser drilling, the mixture of Teflon 13 and carrier liquid or gelatine can easily be removed from the blade or vane 120, 130, for example by introducing the blade or vane 120, 130 in a hot water bath.

The Teflon powder 13 acts as protection, and therefore, in a laser process, use can be made both of the percussion process and of the trepanning process, in order to produce a high-quality bore 19 and to avoid “recast”.

After the holes 19 have been produced, the Teflon powder 13 can be removed together with the gelling agent. This can be assisted by shaking and/or jarring.

Meandering hollow spaces 10 thus also become readily accessible.

The Teflon powder 13 can preferably be reused.

Considerably shorter burning-out in a burnout furnace may still be necessary.

One application also consists in reopening holes in a component 1, 120, 130 if the component 1, 120, 130 is coated with already drilled through-holes and the hollow space 10 is likewise protected.

Owing to its special thermal properties during laser drilling, Teflon is the best means of protection for the inner spaces. Owing to the Teflon powder, alone or in combination with a carrier liquid such as a wax or a water-based solution, it is also possible to ensure better protection on blades or vanes with restricted or non-existent accessibility of the cavities to be protected than with wax without Teflon. This makes it possible to use both the percussion process and the trepanning process.

The Teflon powder can be removed more quickly than the hard wax used to date. Considerable savings are made in the laser drilling process time and in the process preparation and postprocessing owing to the described invention.

In addition, the quality of the bores increases, since both percussion processes and trepanning processes can be used. The Teflon powder can also be used for drilling blade or vane types for which wax is currently used as protection.

The advantage here is that the inner space can be completely filled by filling with powder and therefore can be better protected.

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B 1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, the transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation, e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co—30Ni—28Cr—8Al—0.6Y—0.7Si or Co—28Ni—24Cr—10Al—0.6Y. In addition to these cobalt-based protective coatings, it is also preferable to use nickel-based protective layers, such as Ni—10Cr—12Al—0.6Y—3Re or Ni—12Co—21Cr—11Al—0.4Y—2Re or Ni—25Co—17Cr—10Al—0.4Y—1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1. A process for protecting a component during a laser machining of the component with a hollow space, the process comprising:
filling the hollow space with Teflon powder at least in the region of the region to be machined,
wherein the Teflon powder is introduced into the hollow space with a gelling agent.

2. The process as claimed in claim 1, wherein a water-based gelling agent is used.

3. The process as claimed in claim 1, wherein 50 g/l-300 g/l of gelling agent is used.

4. The process as claimed in claim 1, wherein a surfactant is used.

5. The process as claimed in claim 4, wherein the surfactant is sodium dodecyl hafnate.

6. The process as claimed in claim 4, wherein the concentration of the surfactant is 0.01 g/l-0.5 g/l.

7. The process as claimed in claim 1, wherein 200 g/l-1000 g/l of Teflon is used.

8. The process as claimed in claim 1, wherein the entire hollow space is filled with Teflon powder.

9. The process as claimed in claim 1, wherein the Teflon powder has a grain size of 10 μm-1000 μm.

10. The process as claimed in claim 1, wherein a very short burning-out process is effected after the through-holes have been made for removing the material from the hollow space.

11. The process as claimed in claim 1, wherein the gelling agent is a gelatine.

12. The process as claimed in claim 1, wherein said laser machining comprises laser drilling.

13. The process as claimed in claim 1, the laser machining of the component comprises making a through-hole through a wall of the hollow space of the component.

14. A process for laser drilling a component, comprising:
making a through-hole through a wall of a hollow space of the component, and
protecting the hollow space by the process according to claim 1.

15. A hollow component, comprising:
Teflon powder and gelling agent introduced into in a hollow space of the hollow component.

16. The hollow component as claimed in claim 15, wherein the Teflon powder has a grain size of 10 μm-1000 μm.

17. The hollow component as claimed in claim 15, wherein the gelling agent is a gelatine.
